(19) United States
(12) Patent Application Publication
(10) Pub. No.: US 2015/0238810 A1
(43) Pub. Date: Aug. 27, 2015

(54) SMILE STICK

(71) Applicant: Can of Sunshine, LLC, Rochester, MI (US)

(72) Inventor: Matthew Loria, Rochester, MI (US)

(21) Appl. No.: 14/622,233

(22) Filed: Feb. 13, 2015

Related U.S. Application Data
(60) Provisional application No. 61/944,827, filed on Feb. 26, 2014.

(51) Int. Cl. A63B 23/03; H04L 29/08

(52) U.S. Cl. CPC A63B 23/032; H04L 67/10

(57) ABSTRACT

A device having a pair of wings separated by a center bite section is disclosed. Each wing may be an elongated member and may have a cap at a distal end and a fillet or ramp at a proximate end sloping towards the center bite section. The wings may include various shapes and geometries.

### CROSS-REFERENCE TO RELATED APPLICATIONS

This application claims the benefit of U.S. Provisional Patent Application No. 61/944,827 filed on Feb. 26, 2014. The entire disclosure of the above application is incorporated herein by reference.

### FIELD

The present disclosure relates to a device that promotes use of facial muscles normally used when smiling.

### BACKGROUND

This section provides background information related to the present disclosure and is not necessarily prior art.

Research suggests that smiling can trigger and release brain chemicals and or body responses which may have a positive effect on a person's health by helping the person feel positive emotions and their related effects. Research also suggests that even faking a Duchenne smile can trigger and release brain chemicals, body responses and the related effects of a naturally occurring smile. Because situations may exist where a person may find it difficult to smile or that they are not smiling enough, a device for helping a person smile, or fake a smile, may be desirable.

### SUMMARY

This section provides a general summary of the disclosure, and is not a comprehensive disclosure of its full scope or all of its features.

A device having a pair of wings separated by a center bite section is disclosed. Each wing may be an elongated member and may have a cap at a distal end and a fillet or ramp at a proximate end sloping towards the center bite section. The wings may include various shapes and geometries.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a perspective view of a smile stick according to the principles of the present disclosure;

FIG. 2 is a front view of the smile stick of FIG. 1;

FIG. 3 is a cross-sectional view of the smile stick of FIG. 2 taken along line D-D;

FIG. 4 is a front view of another smile stick according to the principles of the present disclosure;

FIG. 5 is a front view of another smile stick according to the principles of the present disclosure showing materials of different densities used to form the smile stick;

FIG. 6 is a front view of another smile stick according to the principles of the present disclosure;

FIG. 7 is a front view of another smile stick according to the principles of the present disclosure;

FIG. 8 is a front view of another smile stick according to the principles of the present disclosure;

FIG. 9 is a front view of another smile stick according to the principles of the present disclosure;

FIG. 10 is a front view of a novelty attachment for use with the smile stick of FIG. 9;

FIG. 11 is a top view of the novelty attachment of FIG. 10 for use with the smile stick of FIG. 9;

FIG. 12 is another front view of the smile stick of FIG. 9 showing an attachment feature and lanyard;

FIG. 13 is a front view of another smile stick according to the principles of the present disclosure;

FIG. 14 is a front view of another smile stick according to the principles of the present disclosure;

FIG. 15 is a front view of another smile stick according to the principles of the present disclosure;

FIG. 16 is a front view of another smile stick according to the principles of the present disclosure;

FIG. 17 is a front view of another smile stick according to the principles of the present disclosure;

FIG. 18 is a front view of another smile stick according to the principles of the present disclosure;

FIG. 19 is a front view of another smile stick according to the principles of the present disclosure;

FIG. 20 is a front perspective view of another smile stick according to the principles of the present disclosure;

FIG. 21 is a side view of the smile stick of FIG. 20;

FIG. 22 is a perspective view of the smile stick of FIG. 20;

FIG. 23 is a perspective view of another smile stick according to the principles of the present disclosure;

FIG. 24 is a front view of the smile stick of FIG. 23;

FIG. 25 is a front view of another smile stick according to the principles of the present disclosure; and

FIG. 26 is a screen shot of a computer application for use with or without the smile stick of any of the previous figures.

Corresponding reference numerals indicate corresponding parts throughout the several views of the drawings.

### DETAILED DESCRIPTION

Example embodiments will now be described more fully with reference to the accompanying drawings.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

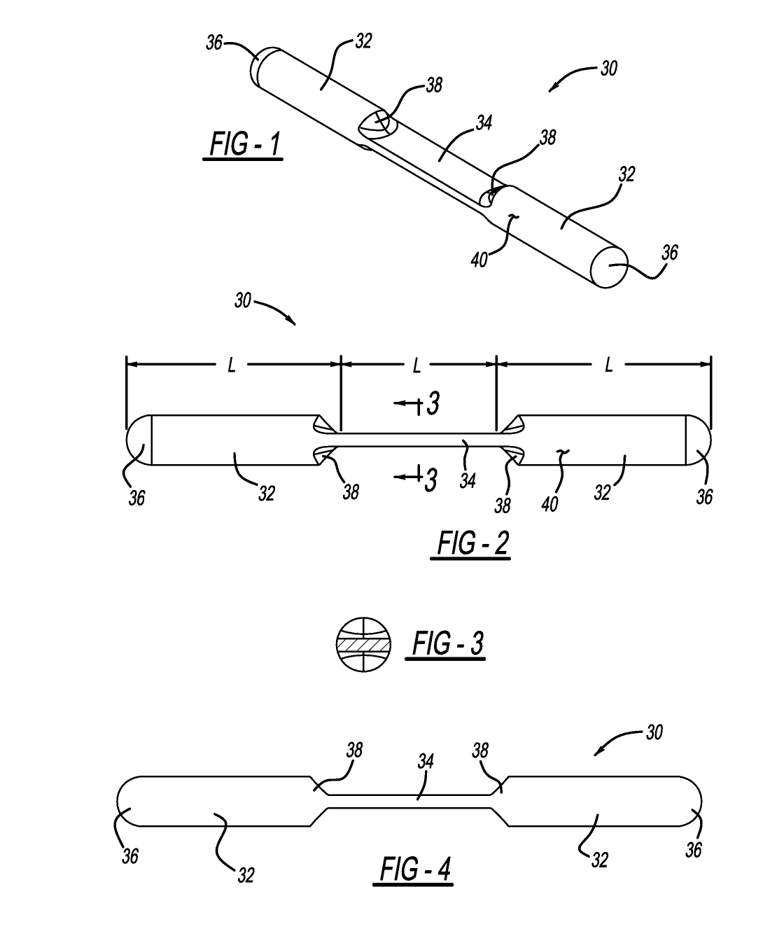

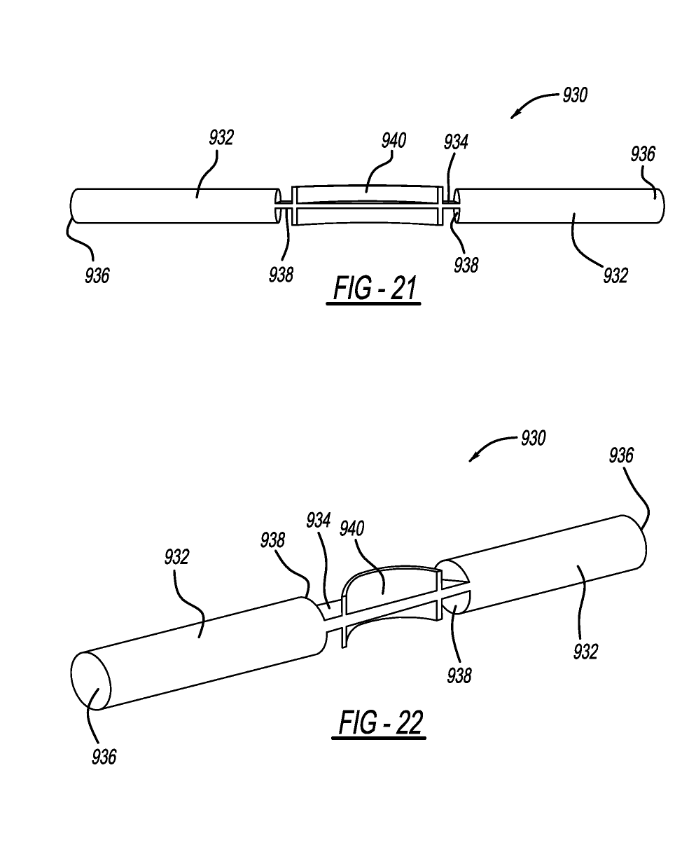

With reference to FIGS. 1-4, a smile stick 30 having a pair of elongated wings 32 separated by an elongated center bite section 34 is shown. Each wing 32 may be a cylindrical member having a length L, and may include a rounded cap 36 at a distal end and a fillet or ramp 38 at a proximate end sloping towards the center bite section 34. The caps 36 and the fillets or ramps 38 may be integrally formed with the wings 32 or may be fixedly attached thereto. The center bite section 34 may be a rectangular member having a length L that may be the same as the length L of each of the wings 32 or, alternatively, may include a different length. The smile stick 30 may also include a timing device 40 associated with at least one of the wings 32 or center bite section 34. During use, as will be described below, the timing device 40 may detect, and may also record, how long the smile stick 30 has been used, and may further sound an alarm or play music at the expiration of a predetermined time interval of use. The timing device 40 may also be incorporated into any of the other smile sticks shown in FIGS. 4-25. With specific reference to FIGS. 2 and 3, the cross-section of the center bite section 34 may be smaller than the cross-section of the wings 32.

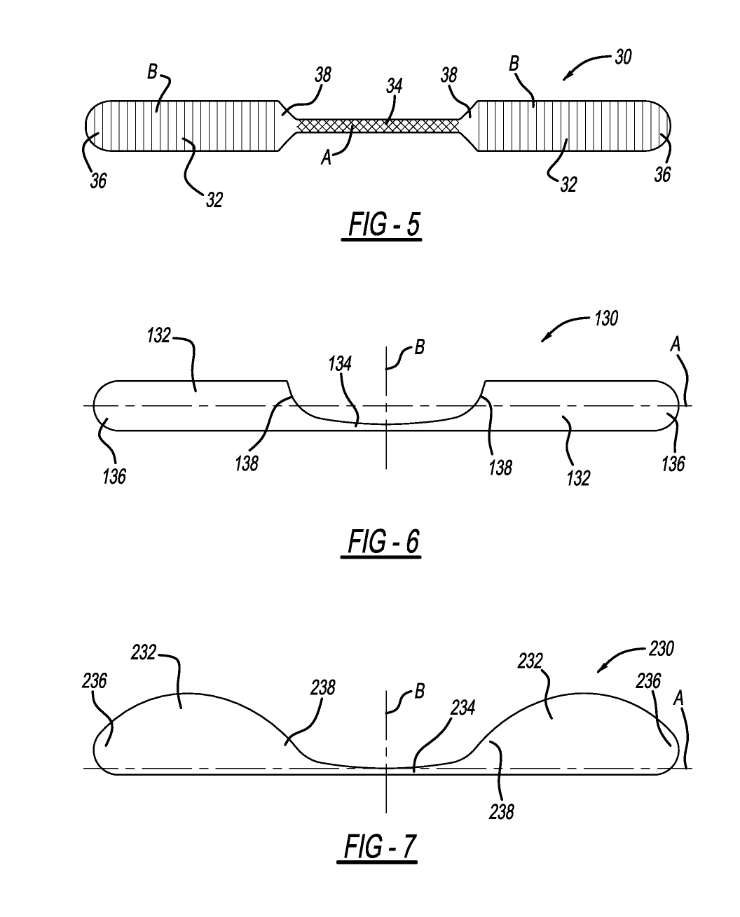

The smile stick 30 and each of the smile sticks described below may be fabricated from a single material such as medical grade latex or plastic, or a species of wood, for example. Accordingly, the wings 32 and center bite section 34 may be integrally formed at the same time during an injection molding process, for example. The smile stick 30 and each of the smile sticks described below may also be fabricated from a plurality of materials. For example, with reference to FIG. 5, the center bite section 34 may be fabricated from a first material A having a first density A′ and the wings 32 may be fabricated from a second material B having a second density B′ that may be different from the first density A′ of the first material A.

During use, a person may deposit the smile stick 30 into their mouth and bite down onto the center bite section 34. Biting down on the center bite section 34 may cause the person to smile or express a fake smile as the increased size of the wings 32—relative to the size of the bite section 34—urge the cheeks and eyes of the person into a position that simulates a smiling position. The timing device 40 may be used to confirm the person is using the smile stick 30 properly, and/or notify the person using the smile stick 30 once a predetermined time interval has expired. Use of the smile stick 30 described above may be the same for any of the other smile sticks disclosed herein. Accordingly, a description of the operation of the following devices shown in FIGS. 6-25 is foregone.

With reference to FIG. 6, another smile stick 130 having a pair of wings 132 separated by a center bite section 134 is shown extending along a first axis A. Each wing 132 may be an elongated member having a cylindrical shape or a rectangular shape, and may be symmetrical about the first axis A and may also be symmetrical about a second, perpendicular axis B. Each wing 132 may have a rounded cap 136 at a distal end and a fillet or ramp 138 at a proximate end sloping towards the center bite section 134. The caps 136 and the filets or ramps 138 may be integrally formed with the wings 132 or may be fixedly attached thereto. The center bite section 134 may be a rectangular or cylindrical member located on or below the first axis A as shown, and may be symmetrical about the second axis B. Along the first axis A, the cross-sections of the center bite section 134 and the wings 132 may be the same, and along the second axis B, the cross-section of the center bite section 134 may be smaller than the cross-section of the wings 132.

With reference to FIG. 7, another smile stick 230 having a pair of wings 232 separated by a center bite section 234 is shown extending along a first axis A. Each wing 232 may be a hemispherically-shaped member that is symmetrical about a second axis B. Each wing 232 may have a cap 236 at a distal end and a fillet or ramp 238 at a proximate end sloping towards the center bite section 234. The caps 236 and the filets or ramps 238 may be integrally formed with the wings 232 or may be fixedly attached thereto. The center bite section 234 may be a rectangular or cylindrical member located on or below the first axis A as shown, and may be symmetrical about the second axis B. Along the first axis A, the cross-sections of the center bite section 234 and the wings 232 may be the same, and along the second axis B, the cross-section of the center bite section 234 may be smaller than the cross-section of the wings 232.

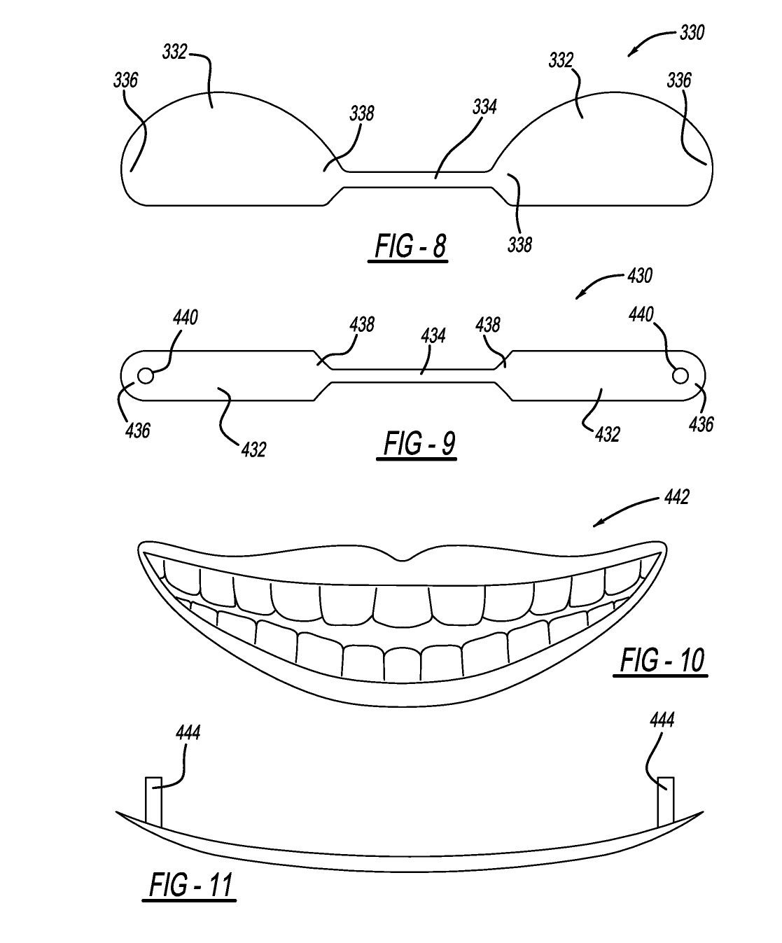

With reference to FIG. 8, another smile stick 330 having a pair of wings 332 separated by as center bite section 334 is shown. Each wing 332 may include a substantially ovoid-shape having a cap 336 at a distal end and a fillet or ramp 338 at a proximate end sloping towards the center bite section 334. The caps 336 and the filets or ramps 338 may be integrally formed with the wings 332 or may be fixedly attached thereto. The center bite section 334 may be a rectangular or cylindrical member extending between the wings 332.

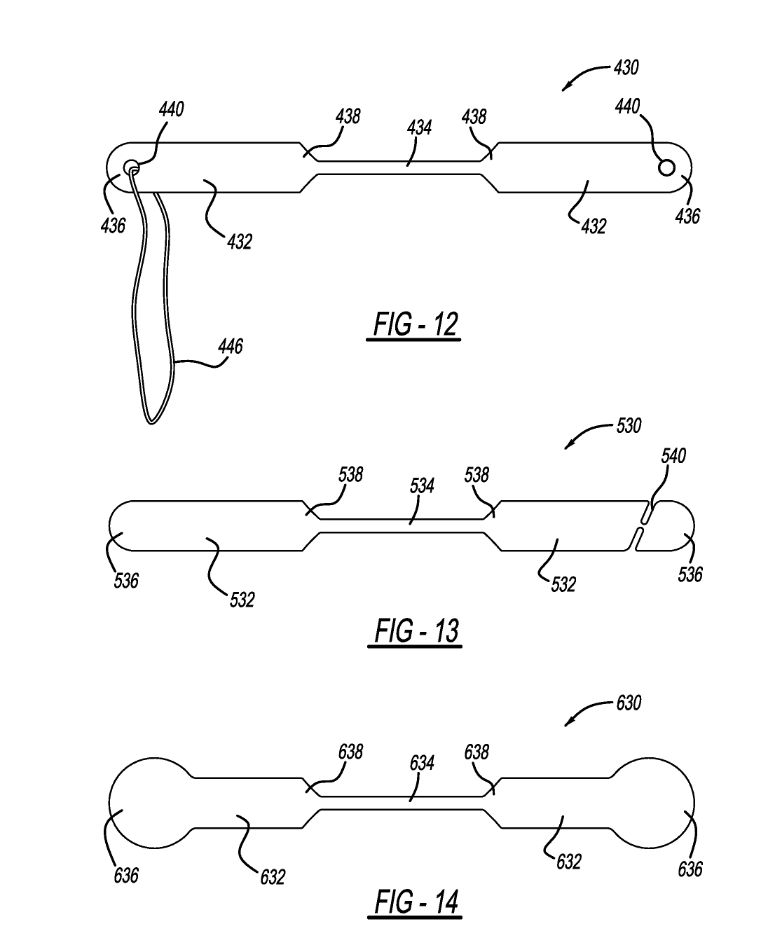

With reference to FIGS. 9 and 12, another smile stick 430 having a pair of wings 432 separated by a center bite section 434 is shown. Each wing 432 may be an elongated member having a cylindrical shape or rectangular shape and may include a rounded cap 436 at a distal end and a fillet or ramp 438 at a proximate end sloping towards the rectangular or cylindrical center bite section 434. The caps 436 and the filets or ramps 438 may be integrally formed with the wings 432 or may be fixedly attached thereto. A bore 440 may extend through at least one of the wings 432 for attaching a novelty accessory 442 thereto. The bore 440 may also be incorporated into any of the other smile sticks disclosed herein. For example, the novelty accessory 442 may be an enlarged smile as shown in FIGS. 10 and 11. The novelty accessory 442 may have at least one boss or protrusion 444 engaging the bore 440 to mount the novelty accessory 442 to the smile stick 430. As shown in FIG. 12, a lanyard 446 may be inserted through one of the bores 440 to aid a person from dropping the smile stick 430 during use and/or to hang the smile stick 430 when not in use.

With reference to FIG. 13, another smile stick 530 having a pair of wings 532 separated by a center bite section 534 is shown. Each wing 532 may be an elongated member having a cylindrical or rectangular shape and may include a rounded cap 536 at a distal end and a fillet or ramp 538 at a proximate end sloping towards the rectangular or cylindrically-shaped center bite section 534. The caps 536 and the filets or ramps 538 may be integrally formed with the wings 532 or may be fixedly attached thereto. A bite notch 540 may be formed onto at least one of the wings 532. The bite notch 540 may also be incorporated into any of the other smile sticks disclosed herein. A person may use the bite notch 540 to hold and retain the smile stick 530 between their teeth to prevent accidental dropping of the smile stick 530 prior to or following use of the smile stick 530 at the center bite section 534.

With reference to FIG. 14, another smile stick 630 having a pair of wings 632 separated by a center bite section 634 is shown. Each wing 632 may be an elongated member having a cylindrical or rectangular shape and may include a cap 636 at a distal end thereof and a fillet or ramp 638 at a proximate end sloping towards the rectangular or cylindrically-shaped center bite section 634. The caps 636 and the filets or ramps 638 may be integrally formed with the wings 632 or may be fixedly attached thereto. The caps 636 may include a variety of shapes such as enlarged bulbs at a distal end thereof. The caps 636 may also be formed into a variety of shapes, providing for the smile stick 630 to resemble a novelty item, such as a dog bone, for example.

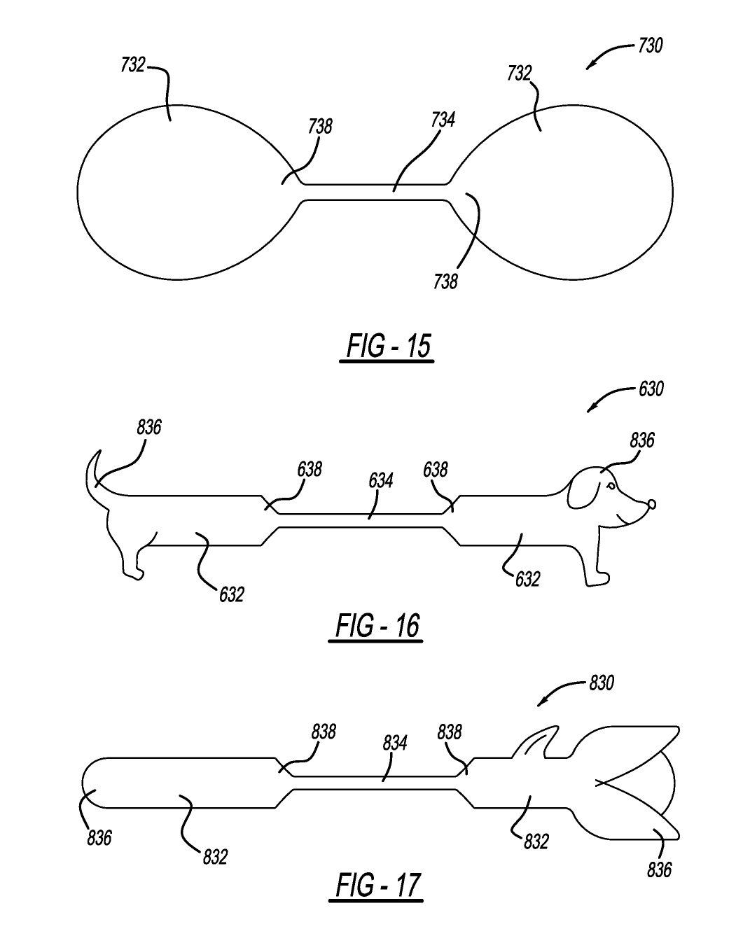

With reference to FIG. 15, another smile stick 730 having a pair of wings 732 separated by a center bite section 734 is shown. Each wing 732 may include a tear-drop shape and may include a fillet or ramp 738 at a proximate end sloping towards the rectangular or cylindrically-shaped center bite section 734. The caps 736 and the filets or ramps 738 may be integrally formed with the wings 732 or may be fixedly attached thereto.

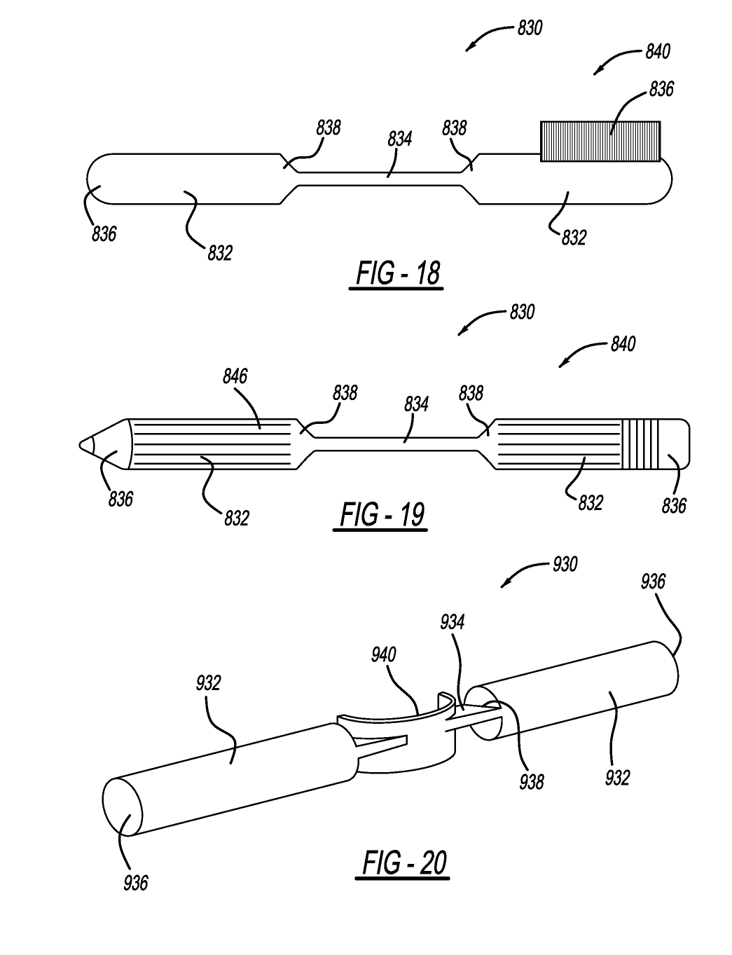

With reference to FIGS. 16-19, another smile stick 830 having a pair of wings 832 separated by a center bite section 834 is shown. Each wing 832 may be an elongated member having a cylindrical or rectangular shape and may include a cap 836 at a distal end and a fillet or ramp 838 at a proximate end sloping towards the rectangular or cylindrically-shaped center bite section 834. The caps 836 and the filets or ramps 838 may be integrally formed with the wings 832 or may be fixedly attached thereto. Each cap 836 may include a shape or geometry resembling certain characters, objects, or devices. For example, the caps 836 may respectively resemble a head and tail of a dog (FIG. 16), a tulip bulb and stem (FIG. 17), a toothbrush and handle (FIG. 18), and/or a pencil—or other writing instrument—and eraser (FIG. 19).

In an alternate embodiment, the smile stick 830 may be integrated with other devices. With reference to FIGS. 18 and 19, the smile stick 830 may be integrated with an oral-care device such as a toothbrush 840, floss holder (not shown), or other oral-care device. For example, the smile stick 830 can be integrated with a toothbrush 840 such that the center bite section 834 is formed onto a handle 842 of the toothbrush 840 (FIG. 18). Alternatively, the smile stick 830 may be integrated with a writing device such as a pencil 844, such that the center bite section 834 is formed onto a shaft 846 of the writing device or pencil 844 (FIG. 19).

With reference to FIGS. 20-22, another smile stick 930 having a pair of wings 932 separated by a center bite section 934 is shown. Each wing 932 may be an elongated member having a cylindrical shape and may include a cap 936 at a distal end and a fillet or ramp 938 at a proximate end sloping towards the center bite section 834. The center bite section 934 may be a rectangular member that includes a mouth guard 940. The mouth guard 940 may be a curved member integrally formed with the center bite section 934 or fixedly attached thereto that covers the user's teeth and gums during use of the smile stick 930. The mouth guard 940 may also help align and position the smile stick 930 within a user's mouth, to help ensure proper use of the smile stick 930. The mouth guard 940 may also be incorporated into any of the other smile sticks disclosed herein. Furthermore, the mouth guard 940 may at least partially surround a user's teeth during use and may include a material that allows the mouth guard 940 to be formed to the particular user's teeth.

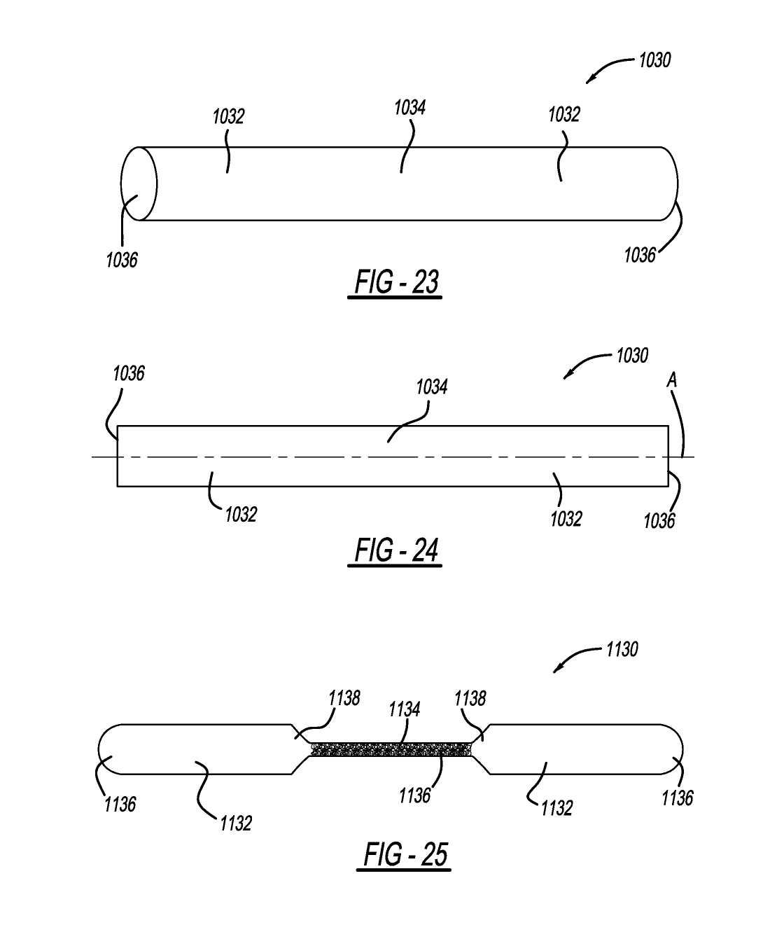

With reference to FIGS. 23 and 24, another smile stick 1030 having a pair of wings 1032 separated by a center bite section 34 is shown extending along a first axis A. Each wing 1032 may include a cap 1036 at a distal end. The smile stick 1030 may have a substantially uniform cross-section along the first axis A.

With reference to FIG. 25, another smile stick 1130 having a pair of wings 1132 separated by a center bite section 1134 is shown. Each wing 1132 may be an elongated member having a cylindrical or rectangular shape and may include a cap 1136 at a distal end and a fillet or ramp 1138 at a proximate end sloping towards the center bite section 1134. The center bite section 1134 may be a rectangular or cylindrical member and may include a moldable area 1136. The moldable area 1136 may be molded over, integrally formed with, or fixedly attached to, the center bite section 1134. The moldable area 1136 may allow a user to create an impression of their teeth and custom-form the center bite section 1134 to the user's teeth to provide for a more-comfortable fit during use of the smile stick 1130. The moldable area 1136 may also be incorporated into any of the other smile sticks disclosed herein—at the respective bite sections.

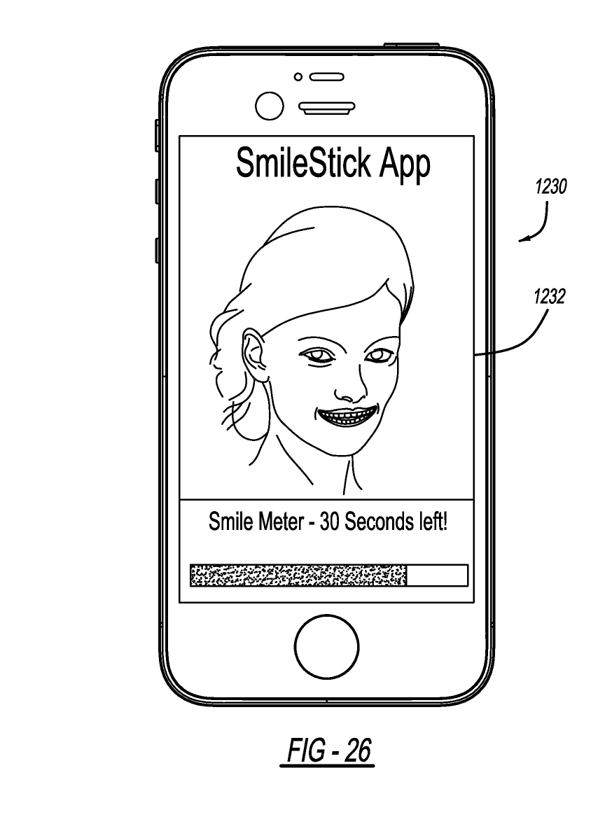

With reference to FIG. 26, a computer application 1230 may be executed by a computer 1232 (i.e., a smart phone, a tablet, etc.) and may be used with any of the previously described smile sticks. The computer application 1230 may be programmed to assess a person's use of any of the previously described smile sticks, for how long a person has used the smile stick, and/or for how much longer a person should use the smile stick. For example, the particular smile stick may include a communication device such as, for example, a micro controller and/or transmitter that communicates with the computer application 1230.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A biting device comprising:
a first section having a first end and a second end, said first end including a first cap;
a middle section having a third end and a fourth end, said third end connected to said second end of said first section; and
a second section having fifth end and a sixth end, said fifth end connected to said fourth end of said middle section, and said sixth end including a second cap;
wherein a cross-section of said middle section along a first plane is smaller than a cross-section of said first and second sections along said first plane, and a cross-section of said middle section along a second plane that is perpendicular to said first plane is the same as a cross-section of said first and second sections along said second plane.

2. The device of claim 1, wherein said first section and said second section are fabricated from a first material having a first density and said middle section is fabricated from a second material having a second density that is different from the first density of the first material.

3. The device of claim 1, wherein at least one of said first section and said second section includes a bore extending therethrough, said bore operable to receive one or both of a novelty attachment and a lanyard for attaching to said device.

4. The device of claim 1, wherein at least one of said first section and said second section includes an attachment feature.

5. The device of claim 1, wherein at least one of said first section and said second section includes a tear-drop shape.

6. The device of claim 1, wherein at least one of said first section and said second section includes a bite notch operable to receive a user's teeth.

7. The device of claim 1, wherein at least one of said first cap and said second cap includes a shape of a flower stem and the other of said at least one of said first cap and said second cap includes a shape of a flower bulb.

8. The device of claim 1, wherein at least one of said first cap and said second cap includes a shape of a dog's tail and the other of said at least one of said first cap and said second cap includes a shape of a dog's head.

9. The device of claim 1, wherein at least one of said first end cap and said second end cap includes an eraser and the other of said at least one of said first end cap and said second end cap includes a writing instrument.

10. The device of claim 1, wherein said middle section includes a material that allows the middle section to be formed to fit a particular user's teeth.

11. The device of claim 1, wherein said middle section includes a mouth guard that at least partially surrounds a user's teeth during use.

12. The device of claim 1, wherein said middle section includes an over-molded portion.

13. The device of claim 1, further comprising a timing device operable to measure the time the device is in a user's mouth.

14. The device of claim 1, further comprising a communication module associated with one of the first section, the second section, and the third section, said communication module in communication with a mobile application.
